(19) United States
(12) Patent Application Publication
(10) Pub. No.: US 2018/0071174 A1
(43) Pub. Date: Mar. 15, 2018

(54) COUGH SPREAD CONTROL DEVICE

(71) Applicant: Cough-Clean, Inc., North Ridgeville, OH (US)

(72) Inventors: Russell J. PARKER, North Ridgeville, OH (US); Willis Yehl, Hutto, TX (US)

(21) Appl. No.: 15/445,053

(22) Filed: Feb. 28, 2017

Related U.S. Application Data
(63) Continuation-in-part of application No. 29/587,306, filed on Dec. 12, 2016.
Application No. 29/587,306 is a continuation-in-part of application No. 29/620,268, filed on Sep. 9, 2016.

(51) Int. Cl. A61J 19/00; B01D 39/16; B01D 46/10; B01D 46/00

(52) U.S. Cl. CPC A61J 19/00; B01D 39/1615; B01D 46/10; B01D 2275/202; A61J 2205/30; B01D 2275/10; B01D 46/0028

(57) ABSTRACT

Disclosed is a device to control the spread of airborne pathogens emanating from a cough. The device has an elongated substantially hollow body comprising a longitudinal axis and opposite proximal and distal openings. The proximal opening defines a region for engaging the device with the mouth of a user that allows exhaled air from a cough to enter an interior space of the elongated body. An end member is removably engaged to the distal opening of the elongated body. The end member has an elongated substantially hollow body comprising a longitudinal axis connecting a proximal opening and a distal wall. The proximal opening of the end member is engaged with the distal opening of the elongated body. The distal wall of the end member has one or more openings to permit air flow therethrough. A filter element is positioned within the end member adjacent the distal wall.

### CROSS REFERENCE TO RELATED APPLICATIONS

The present application is a continuation-in-part of co-pending U.S. Design patent Ser. No. 29/587,306, filed Dec. 12, 2016, which is a continuation-in-part of co-pending U.S. Design patent application Ser. No. 29/620,268 filed on Sep. 9, 2016, from which applications priority is claimed, and which are incorporated herein by reference.

### TECHNICAL FIELD

The present disclosure relates to a device that mitigates or prevents the spread of airborne pathogens. The disclosure also relates to a device for the treatment of air exhaled by humans and animals.

### BACKGROUND

Numerous infectious diseases are spread by coughing which expels bacteria and viruses into the air. About 3,000 droplets of saliva, traveling up to 100 miles per hour, are expelled in a single cough. Bacteria and viruses can survive outside the body and remain suspended in the air for long periods of time. Diseases that are commonly spread by coughing include bacterial meningitis, chickenpox, common cold, influenza, mumps, strep throat, tuberculosis, measles, rubella, whooping cough, Severe Acute Respiratory Syndrome (“SARS”) and leprosy. The cough of an individual infected with influenza may contain as many as 200 million particles of the influenza virus, which can survive on hard surfaces for up to several days.

There are a known devices for containing the spread of airborne pathogens resulting from coughing. However, many of these devices do not adequately prevent the spread of airborne pathogens while others are simply too impractical for use by the general public.

Tissues and handkerchiefs do not adequately prevent the spread of airborne pathogens created by a cough because these articles become contaminated after use and may contact other persons spreading the pathogens contained therein. In addition, thorough washing of the hands is still recommended after coughing into a tissue or handkerchief. This is often impractical for care givers, cooks, waiters, cashiers, hairdressers, flight attendants, travelers, sales people, and the like working closely with people. Also, a cough occurs with little warning and the individual does not have time to reach into his or her pocket for a tissue or is carrying an object and is unable to obtain or use a tissue or handkerchief.

Masks are unsightly and unlikely to be worn by the general public. Also, placing a mask on one's face would limit the amount of air available for inhalation and would require the user to remove the mask from their face from time to time to inhale more easily. This is particularly problematic for children suffering from asthma. Also, the permanent mounting of a mask over one's face is not practical for use by those whose coughing is limited to occasional instances.

Other known solutions are generally bulky and complicated devices. Their large size prevents a person from using them discretely without embarrassment. Their complicated designs are expensive to manufacture and sell to consumers, reducing their impact as a viable means to protect public health from airborne spread of pathogens. The large size of these designs also makes it difficult for people to transport in a pocket, purse or other small article.

Therefore, there is a need in the art to provide a device that is small, easily concealed when being used, allows for easy inhalation after coughing, prevents contamination of a user's hands after a coughing episode, and adequately prevents the spread of airborne pathogens generated by coughing.

### BRIEF DESCRIPTION

Disclosed is a device to control the spread of airborne pathogens emanating from a cough comprising an elongated substantially hollow body comprising a longitudinal axis and opposite proximal and distal openings, at least a portion of the elongated body has a continuously increasing diameter from said proximal opening to said distal opening, an end member is removably engaged to said distal opening of said elongated body, said end member comprises an elongated substantially hollow body comprising a longitudinal axis connecting a proximal opening and a distal wall, the proximal opening is engaged with said distal opening of said elongated body, said distal wall of said end member has one or more openings to permit air flow therethrough, wherein a filter element is positioned within the end member adjacent the distal wall.

### BRIEF DESCRIPTION OF THE DRAWINGS

FIG. 1 is a perspective view showing mainly top, rear and left portions of a first embodiment of the device.

FIG. 2 is a perspective view showing mainly bottom, rear and right portions of the device shown in FIG. 1.

FIG. 3 is a front view of the device shown in FIG. 1.

FIG. 4 is a rear view of the device shown in FIG. 1.

FIG. 5 is a top view of the device shown in FIG. 1.

FIG. 6 is a bottom view of the device shown in FIG. 1.

FIG. 7 is a perspective view showing mainly front and left portions of the body of the device shown in FIG. 1.

FIG. 8 is a left end view of the device shown in FIG. 1.

FIG. 9 is a right end view of the device shown in FIG. 1.

FIG. 10 is a perspective exterior view of an end member that is engaged with the elongated body of the device shown in FIG. 1.

FIG. 11 is an interior view of the end member of the device shown in FIG. 1.

FIG. 12 is an exploded view of the device shown in FIG. 1.

FIG. 13 is a left end view of the device shown in FIG. 1 containing a filter element.

### DETAILED DESCRIPTION

Disclosed a device to control the spread of airborne pathogens by containing such pathogens emanating from a cough. A user of the device can cough into the device to mitigate or prevent the transmission of airborne pathogens. The device may be used by adults and children in offices, schoolrooms, churches, private residences and other places of gathering.

According to certain illustrative embodiments, the device comprises an elongated substantially hollow body comprising a longitudinal axis and opposite proximal and distal openings. At least a portion of the elongated body has a continuously increasing diameter. The proximal opening defines a region for engaging the device with the mouth of a user and allows exhaled air from a cough to enter an interior space of the elongated body. An end member is removably engaged with the distal opening of the elongated body.

According to certain embodiments, at least a portion of the elongated body has a continuously increasing diameter. In certain embodiments, at least a portion of the elongated body has a continuously increasing diameter from the proximal opening to the distal opening. According to certain embodiments, the proximal opening of the elongated body is substantially oval-shaped in cross section and the distal opening of the elongated body is substantially round in cross section.

The end member engages with the distal opening of the elongated body. The end member may be removed from the distal opening of the elongated body for cleaning or replacement. The end member comprises an elongated substantially hollow body comprising a longitudinal axis connecting a proximal opening and a distal wall. The phrase “substantially hollow” means that the interior space of the elongated body allows air to flow laterally through the elongated body. The proximal opening of the end member is engaged with the distal opening of the elongated body.

According to certain embodiments, the end member comprises an elongated substantially hollow body comprising a longitudinal axis connecting proximal opening and distal wall. The phrase “substantially hollow” means that the interior space of the end member allows air to flow laterally through the end member. The distal wall has a plurality of openings to permit air flow therethrough. A filter member is positioned within end member adjacent distal wall allowing air to pass through the openings, but preventing airborne pathogens from being released into the surrounding atmosphere. According to certain embodiments, the end member has a cap configuration.

The end member may be attached to the outer or inner surface of the distal opening of the elongated body. According to certain embodiments, the end member is positioned around the outer surface of the distal opening of the elongated body. By way of illustration, but not limitation, the end member may have a snap fit engagement with the distal opening of the elongated body. In further embodiments, the end member has a friction fit engagement with the distal opening of the elongated body. In yet further embodiments, the end member has a threaded engagement with the distal opening of the elongated body. According to this embodiment, the outer surface adjacent the distal opening of the elongated body comprises an externally threaded portion that engages with an internally threaded portion on the inner surface of the end member.

The distal wall of the end member may have a crisscross configuration. The filter element may be positioned within the end cap adjacent the distal wall. The filter element allows air to pass through the one or more openings, but captures airborne pathogens from being released into the surrounding atmosphere. As a user expels bodily fluids by coughing, the filter element mitigates or prevents the particulate matter from escaping, while allowing the cleaned/filtered air to flow through the filter and into the surrounding atmosphere.

The filter element may comprise one layer. According to certain embodiments, the filter element comprises at least two layers. According to certain embodiments, the filter element comprises at least three layers. According to certain embodiments, the filter element comprises at least four layers. According to certain embodiments, the filter element comprises at least five layers. The filter element may be composed of a plurality of layers comprising absorbent fibrous material such as cotton. Each of these layers may have characteristics of elasticity so as to return to an original shape after being subjected to the force of a cough. The filter element may be composed of a woven and/or non-woven material. The filter element may be composed of inorganic and/or organic material.

According certain embodiments, the filter element is configured to conform to the shape of the circumference of the distal wall of the end member. For example, the filter element may have a round configuration to conform to the round distal wall of the end member. The filter element may have a friction fit engagement with the end member thereby preventing movement of the filter element during use.

A microbicide selected from the group consisting of an antiviral, antimicrobial, antibacterial or combinations thereof may be at least partially coated on and/or at least partially impregnated in, the filter element. By way of illustration, but not limitation, the antibacterial may be selected from the group consisting of benzalkonium chloride (BAC), cetyl trimethylammonium bromide (CTMB), cetylpyridinium chloride (CPC), benzethonium chloride (BZT) or any combination thereof.

The longitudinal axis of the elongated body may transition in diameter from the proximal opening to the distal opening. According to this embodiment, the proximal opening may have a substantially oval-shaped configuration with the major axis horizontal and the minor axis vertical in normal use by a user standing or sitting up, and the distal opening may have a substantially round configuration. The oval-shaped configuration allows the proximal opening to enter and exit the user's mouth freely. In certain embodiments, the proximal opening of the elongated body provides a substantially fluid tight seal of the device against a user's mouth area.

The outer surface of the elongated body of the device may include an attachment mechanism such as an eyelet that attaches to a lanyard or the like and allows a user to wear the device.

The device may be composed of metals, alloys, polymers, plastics, composite materials, fiberglass or combinations thereof. By way of illustration, but not limitation, suitable plastic material includes polypropylene, or other polymeric material known in the field. According to certain illustrative embodiments, the device is manufactured from non-metallic material. The device may be provided in any suitable shape or size. For example, the device may have a circular, oval, square, trapezoid, or hexagon shape.

The inner walls of the elongated body may be substantially smooth to facilitate airflow towards the distal opening where the filter element is positioned. The smooth surface also provides an easy-to-clean surface and decreases the potential for bacterial growth.

Also disclosed is a method of controlling the spread of airborne pathogens emanating from a cough. The method comprises engaging a user's mouth with the device and coughing into the device. Also disclosed is a method for treating air and particulate generated from a cough by utilizing any of the disclosed devices. The method comprises coughing into the proximal opening of the device and venting the air and particulate generated from the cough through the distal opening, in a direction away from a user's mouth and hands.

According to certain embodiments, any of the disclosed methods capture at least about 90% of the airborne pathogens generated by a cough. In further embodiments, the method captures at least about 92.5% of the airborne pathogens generated by a cough. In further embodiments, the method captures at least about 95% of the airborne pathogens generated by a cough. In further embodiments, the method captures at least about 97.5% of the airborne pathogens generated by a cough. In further embodiments, the method captures at least about 99% of the airborne pathogens generated by a cough.

The device is readily understood when read in conjunction with the illustrative embodiments described below. It should be noted that the device is not limited to any of the illustrative embodiments shown in the drawing figures, but rather should be construed in breadth and scope in accordance with the disclosure provided herein.

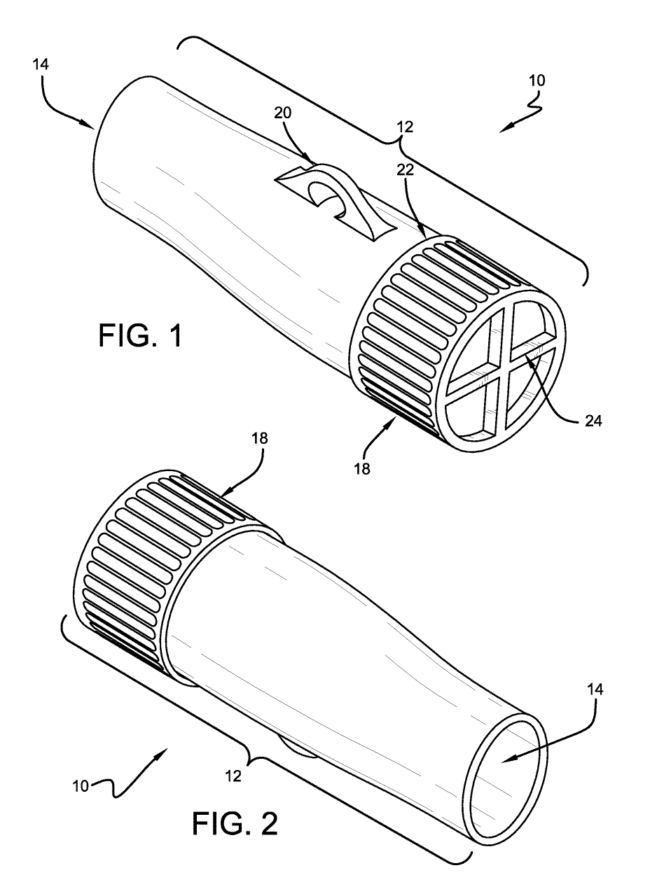

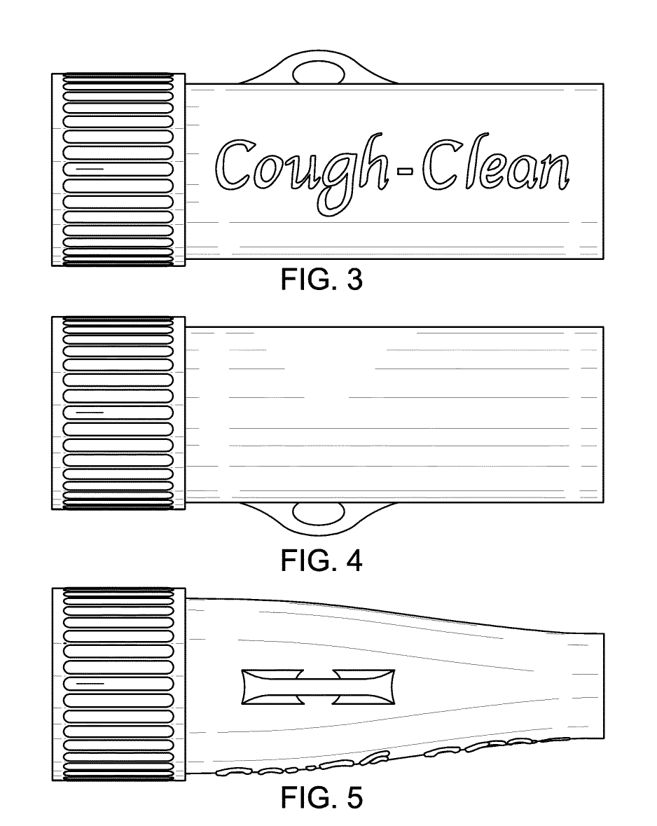

FIG. 1 is a perspective view showing mainly top, rear and left portions of a first illustrative embodiment of device 10. Device 10 is generally comprised of an elongated body 12. Elongated body 12 comprises opposite proximal 14 and distal (not shown; covered by end member) openings. Elongated body 12 extends along longitudinal axis extending between proximal 14 and distal openings. Elongated body 12 has a continuously increasing diameter along at least a portion of elongated body 12 between proximal opening 14 to distal opening. Proximal opening 14 has a substantially oval-shaped configuration when viewed in cross section. Distal opening has substantially round configuration when viewed in cross section. It will be appreciated by those skilled in the art that elongated body 12 can take on a variety of shapes and configurations, and is not limited to the shape depicted in the illustrative drawings. Attachment mechanism 20 on outer surface of elongated body 12 allows for device 10 to be attached to a lanyard or the like. Proximal opening 22 of end member 18 is attached to distal opening of elongated body 12. End member 18 has a generally round configuration, although this shape should be considered to be non-limiting. End member 18 is removably engaged to distal opening of elongated body 12. End member 18 comprises an elongated substantially hollow body comprising a longitudinal axis connecting proximal opening 22 and distal wall 24. Distal wall 23 has a plurality of openings to permit air flow therethrough. Filter member (not shown) is positioned within end member 18 adjacent distal wall 23 allowing air to pass through the openings, but preventing airborne pathogens from being released into the surrounding atmosphere.

FIG. 2 is a perspective view showing mainly bottom, rear and right portions of the device 10 shown in FIG. 1. Device 10 is generally comprised of an elongated body 12. Elongated body 12 comprises opposite proximal 14 and distal (not shown; covered by end member) openings. Elongated body 12 extends along longitudinal axis extending between proximal 14 and distal openings. Proximal opening 14 has a substantially oval-shaped configuration when viewed in cross section. Distal opening has substantially round configuration when viewed in cross section. Proximal opening 22 of end member 18 is removably engaged to distal opening of elongated body 12.

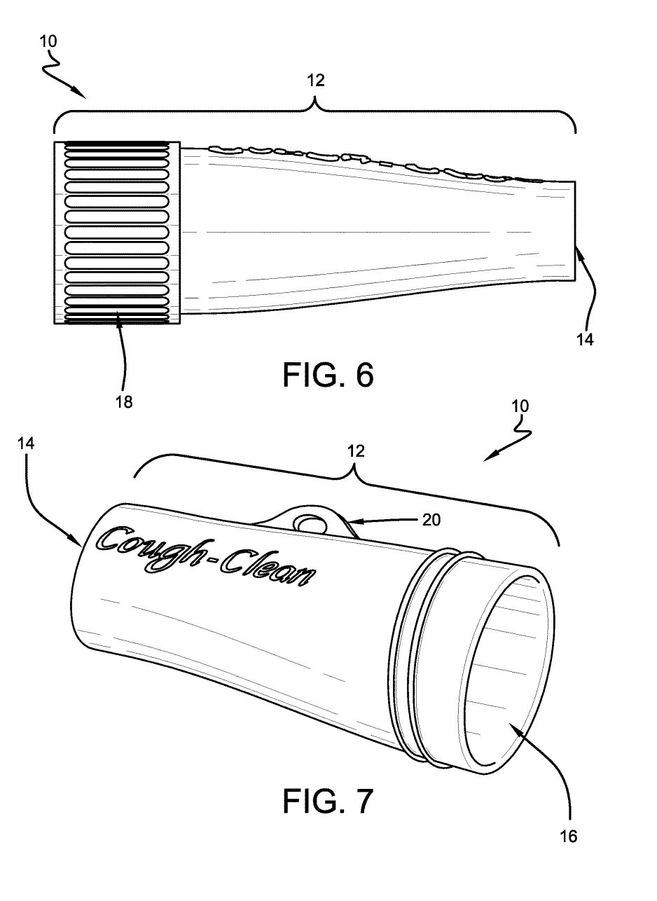

FIG. 6 is a bottom view of the device shown in FIG. 1. Device 10 is generally comprised of an elongated body 12. Elongated body 12 comprises opposite proximal 14 and distal (not shown; covered by end member) openings. Elongated body 12 extends along longitudinal axis extending between proximal 14 and distal openings. Proximal opening 14 has a substantially oval-shaped configuration when viewed in cross section. Distal opening 16 has substantially round configuration when viewed in cross section. Proximal opening 22 of end member 18 is removably engaged to distal opening of elongated body 12.

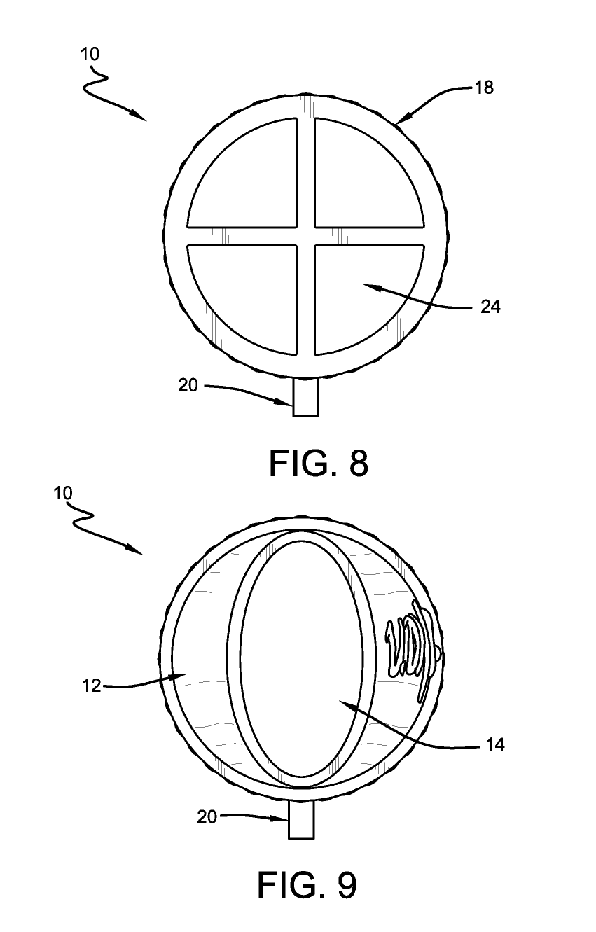

FIG. 7 is a perspective view showing mainly front and left portions of the device 10 shown in FIG. 1, and without end member (not shown) engaged with distal opening 16 of elongated body 12. Device 10 is generally comprised of an elongated body 12. Elongated body 12 comprises opposite proximal 14 and distal 16 openings. Proximal opening 14 has a substantially oval-shaped configuration when viewed in cross section. Distal opening 16 has substantially round configuration when viewed in cross section. Outer surface of elongated body 12 adjacent distal opening 16 comprises an externally threaded portion that engages with threaded portion on inner surface of end member.

FIG. 8 is an end view of distal wall 24 of end member 18. Proximal opening (not shown) of end member 18 is attached to elongated body (not shown). End cap 18 has a generally round configuration when viewed in cross section. At least one filter element (not shown) is disposed within end member 18 adjacent distal wall 24. Distal wall 24 of end member 18 has a crisscross configuration, although this shape should be considered to be non-limiting. Filter element is positioned on distal wall 24 allowing air to pass through the openings, but prevents airborne pathogens from being released into the surrounding atmosphere. Attachment mechanism 20 on outer surface of elongated body allows for device 10 to be attached to a lanyard or the like.

FIG. 9 is an end view of the proximal opening 14 of the elongated body 12 of the device 10. Proximal opening 14 has a substantially oval-shaped configuration when viewed in cross section. Attachment mechanism 20 on outer surface of elongated body allows for device 10 to be attached to a lanyard or the like.

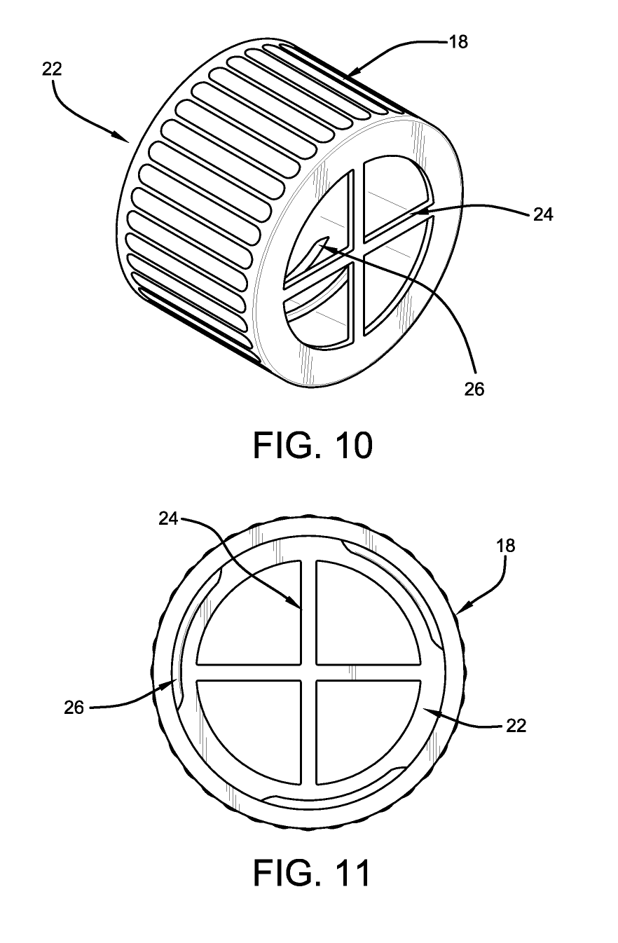

FIG. 10 is a perspective exterior view of end member 18. Proximal opening 22 of end member 18 is attached to elongated body (not shown). End member 18 has a generally round configuration when viewed in cross section. At least one filter element (not shown) is disposed within end member 18 adjacent distal wall 24. Distal wall 24 of end member 18 has a crisscross configuration, although this shape should be considered to be non-limiting. Outer surface of end member 18 includes raised ribs for gripping end member 18. Inner surface of end member contains continuous or discontinuous threads 26 for engaging outer threaded surface of distal opening of elongated body (not shown).

FIG. 11 is an end view of the proximal opening 22 of end member 18. Proximal opening 22 of end member 18 is attached to elongated body (not shown). End member 18 has a generally round configuration when viewed in cross section. At least one filter element (not shown) is disposed within end member 18 adjacent distal wall 24. Distal wall 24 of end member 18 has a crisscross configuration, although this shape should be considered to be non-limiting. Inner surface of end member 18 contains discontinuous threads 26 for engaging outer threaded surface of distal opening of elongated body (not shown).

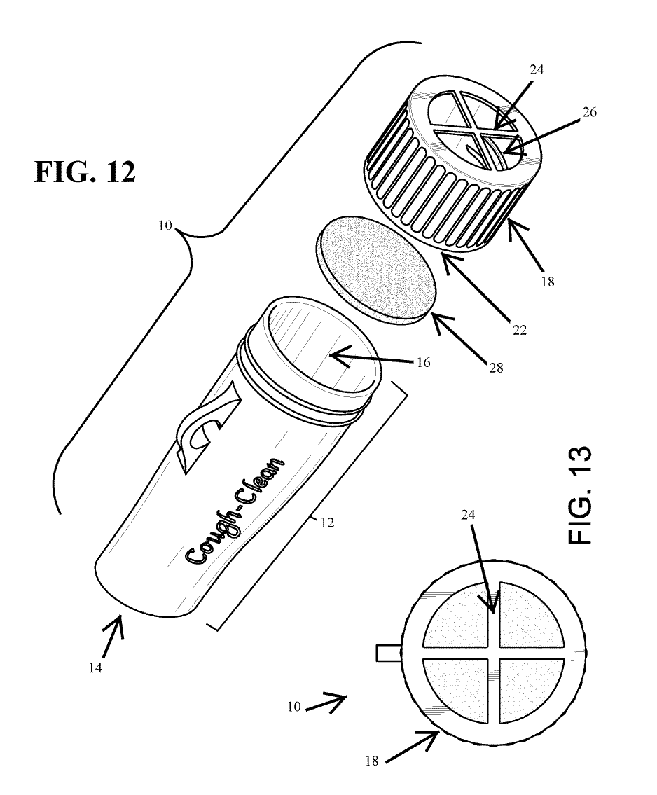

FIG. 12 is an exploded view of the device 10 shown in FIG. 1. Device 10 is generally comprised of an elongated body 12. Elongated body 12 comprises opposite proximal 14 and distal 16 openings. Elongated body 12 extends along longitudinal axis extending between proximal 14 and distal 16 openings. Elongated body 12 has a continuously increasing diameter along at least a portion of elongated body 12 between proximal opening 14 to distal 16 opening. Proximal opening 14 has a substantially oval-shaped configuration when viewed in cross section. Distal opening 16 has substantially round configuration when viewed in cross section. Proximal opening 22 of end member 18 is attached to distal opening 16 of elongated body 12. End member 18 is removably engaged to distal opening of elongated body 12. End member 18 comprises an elongated substantially hollow body comprising a longitudinal axis connecting proximal opening 22 and distal wall 24. Distal wall 23 has a plurality of openings to permit air flow therethrough. Filter member 28 is positioned within end member 18 adjacent distal wall 23 allowing air to pass through the openings, but preventing airborne pathogens from being released into the surrounding atmosphere.

FIG. 13 is an end view of distal wall 24 of end member 18. Proximal opening (not shown) of end member 18 is attached to elongated body (not shown). End cap 18 has a generally round configuration when viewed in cross section. At least one filter element (not shown) is disposed within end member 18 adjacent distal wall 24. Distal wall 24 of end member 18 has a crisscross configuration, although this shape should be considered to be non-limiting. Filter element 28 is positioned on distal wall 24 allowing air to pass through the openings, but prevents airborne pathogens from being released into the surrounding atmosphere.

While the device has been described in connection with various embodiments, it is to be understood that other similar embodiments may be used or modifications and additions may be made to the described embodiments for performing the same function. Furthermore, the various illustrative embodiments may be combined to produce the desired results. Therefore, the device should not be limited to any single embodiment.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A device to control the spread of airborne pathogens from a cough, comprising:
an elongated substantially hollow body comprising a longitudinal axis and opposite proximal and distal openings, and wherein the diameter of said elongated body has an increasing diameter along at least a portion of the longitudinal axis;
an end member removably engaged to said distal opening of said elongated body, said end member comprises an elongated substantially hollow body comprising a longitudinal axis connecting a proximal opening and a distal wall, said proximal opening of said end member is engaged with said distal opening of said elongated body, said distal wall has a plurality of openings to permit air flow therethrough; and
a filter member positioned within said end member adjacent said distal wall.

2. The device of claim 1, wherein said proximal opening of said elongated body has a substantially oval-shaped configuration.

3. The device of claim 1, wherein said distal opening of said elongated body has a substantially round configuration.

4. The device of claim 1, wherein said end member is engaged around an outer surface of said distal opening of said elongated body.

5. The device of claim 1, wherein said distal wall of said end member has a crisscross configuration.

6. The device of claim 1, wherein said proximal opening of said end member has a snap fit engagement with said distal opening of said elongated body.

7. The device of claim 1, wherein said proximal opening of said end member has a friction fit engagement with said distal end of said elongated body.

8. The device of claim 1, wherein said proximal opening of said end member has a threaded engagement with said distal end of said elongated body.

9. The device of claim 1, wherein said filter element is removable.

10. The device of claim 1, wherein a microbicide selected from the group consisting of an antiviral, antimicrobial, antibacterial or combinations thereof is a least partially coated on, or at least partially impregnated in, said filter element.

11. The device of claim 1, wherein said filter element comprises a fibrous material.

12. The device of claim 1, wherein said filter element comprises at least one HEPA filter.

13. The device of claim 1, wherein said filter element comprises at least two layers.

14. The device of claim 1, wherein an outer surface of said elongated body comprises an attachment mechanism for coupling to a carrying mechanism.

15. The device of claim 14, wherein said carrying mechanism comprises a lanyard.

16. The device of claim 1, wherein said device is constructed of non-metallic material.

17. A method for controlling the spread of airborne pathogens emanating from a cough, comprising:
engaging the device of claim 1 with a mouth of a user; and
coughing into said device.

18. The method of claim 17, wherein said device captures at least about 90% of said airborne pathogens.

19. The method of claim 17, wherein said device captures at least about 92.5% of said airborne pathogens.

20. The method of claim 17, wherein said device captures at least about 95% of said airborne pathogens.
